(19) United States
(12) Patent Application Publication
(10) Pub. No.: US 2005/0078668 A1
(43) Pub. Date: Apr. 14, 2005

(54) Network element having a redirect server

(76) Inventors: Joel L. Wittenberg, El Cerrito, CA (US); Robert G. Kilfoyle, Campbell, CA (US); Michael D. Tracy, Foster City, CA (US); Thomas M. Stoner, Raleigh, NC (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/682,514

(22) Filed: Oct. 8, 2003

(51) Int. Cl. H04L 12/56

(52) U.S. Cl. 370/389; 370/238

(57) ABSTRACT

A method and apparatus for providing redirect services are described herein. According to one embodiment, there is a service selection network element used to provide access of computing devices to a set of one or more services provided by one or more providers. In addition, the service selection network element includes a redirect facility and a set of routing policies stored in a machine readable medium within the service selection network element to handle redirect services within the service selection network element. Furthermore, the routing policies optionally include one or more replacement routing policies for each of the routing policy corresponding to the respective context. Other methods and apparatuses are also described.

The present invention relates generally to the field of communications. More particularly, this invention relates to a network element having a redirect server.

### BACKGROUND

In the field of communications, the need for high-speed transmission of data, including video and audio, has continued to increase. Moreover, there has been an increase in the selection of services by which users can connect to a network, such as the Internet. Specifically, Internet Service Providers (ISPs) may allow for connectivity to the Internet through lower-speed connections at different rates, such as 56 kilobits/second, by employing a Plain Old Telephone Service (POTS) line. Other choices for connection, which are at higher speeds, into a network can include Integrated Services Digital Network (ISDN), Digital Subscriber Line (DSL) service, and cable modem service over a Radio Frequency (RF) cable line. Further, other types of content providers may enable a subscriber to receive different types of media, such as a video stream, audio stream, etc.

An Internet services wholesaler typically resells Internet accesses to other ISPs, thus freeing those ISPs from the necessity of creating and maintaining their own network infrastructure. There has been an increase in demand by the ISPs to allow a redirection of an HTTP (hyper text transport protocol) request, via a redirect server, to another site, such as a Web portal, for some other purposes, such as billing purposes. Currently, a redirect server is typically implemented as a dedicated redirect server separated from a service selection network element (e.g., operated by a wholesaler) or maintained by an ISP or a content provider. FIG. 1 is block diagram illustrating a conventional redirect process. Referring to FIG. 1, when service selection network element 102 receives a packet from a subscriber of a remote client 101 to access the Internet via ISP 104, service selection network element 102 determines whether the packet should be redirected to another site based on a set of subscriber-based routing policies. If service selection network element 102 determines that the packet from the subscriber requires to be redirected to another site, service selection network element 102 transmits the packet, via a physical interface (e.g., port 107) to an external dedicated redirect server 103. In return, redirect server 103 returns a redirect address (e.g., URL) to service selection network element 102 which forwards the redirect address back to client 101. The browser of client 101 then accesses the Web site indicated by the redirect URL, via service selection network element 102 again and ISP 104.

Typically, redirect server 103 is external to service selection network element 102 and they are required to be on the same physical subnet. Otherwise, when the packet is forwarded by service selection network element 102 to redirect server 103, the header of the packet (e.g., IP header) has to be rewritten to match the IP address (e.g., destination IP address) of redirect server 103. In addition, since redirect server 103 and service selection network element 102 are typically separate physical entities, there must be a physical interface, such as port 107, involved. Furthermore, the redirection policies have to be on a per subscriber basis.

### BRIEF SUMMARY

A method and apparatus for providing redirect services are described herein. According to one embodiment, there is a service selection network element used to provide access of computing devices to a set of one or more services provided by one or more providers. In addition, the service selection network element includes a redirect facility and a set of routing policies stored in a machine readable medium within the service selection network element to handle redirect services within the service selection network element. Furthermore, the routing policies optionally include one or more replacement routing policies for each of the routing policy corresponding to the respective context. Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating a typical network redirect service configuration.

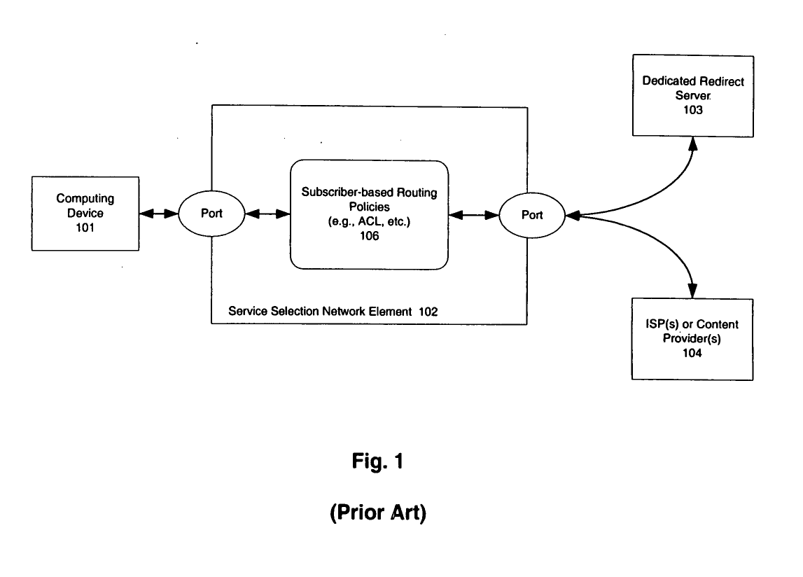

FIG. 2A is a block diagram illustrating an exemplary network redirect service configuration according to one embodiment of the invention.

FIG. 2B is a block diagram illustrating an alternative view of an exemplary network redirect service configuration according to an embodiment of the invention.

FIG. 3 is a block diagram illustrating an exemplary network redirect service configuration according to another embodiment of the invention.

FIG. 4 is a flow diagram illustrating an exemplary process for redirect services according to one embodiment of the invention.

FIG. 5 is a block diagram illustrating exemplary routing policies including redirect policies, according to one embodiment of the invention.

FIG. 6 is a diagram illustrating a page displaying a redirect message according to one embodiment of the invention.

FIG. 7 is a diagram illustrating a new subscriber login page according to one embodiment of the invention.

FIG. 8 is a diagram illustrating a known subscriber login page according to one embodiment of the invention.

### DETAILED DESCRIPTION

Methods and apparatuses for processing redirection of packets within a single network element are described. In one embodiment of the invention, a service selection network element includes a built-in redirect server that allows the HTTP traffic to be redirected to the network element itself. The redirect server allows for the redirection of selected subscriber's HTTP requests to a specific, not necessarily related, URL (uniform resource locator). Further configuration information, such as routing or redirect policies, allows the built-in redirect server to redirect the HTTP request to an external HTTP server via one or more internal redirect routing policies, which may be configured on a per context basis (e.g., per virtual router basis) or on a per subscriber basis. Using a built-in HTTP server to perform the redirection greatly reduces the need for the ISP to maintain its own HTTP server to perform the redirection.

According to one embodiment, the redirection may be implemented permanently. Alternatively, the redirection may be implemented temporarily for a period of time, which may be configured on a per context basis or on a per subscriber basis. If the redirection is set up for a fixed time period, according to one embodiment, the time period may start with the reception of the first customer packet which is actually redirected, instead of the start of the subscriber session. The redirection may be enabled on a per subscriber basis (e.g., as a result of the authentication information obtained at the session establishment).

According to one embodiment, an Internet access wholesaler operating a service selection network element with a built-in redirect server may have one or more providers, such as service providers (e.g., ISPs) and information providers (e.g., content providers), who wish to redirect their HTTP customers in a manner that one provider's redirection does not interfere with another provider's redirection, nor with any non-redirect traffic. The information providers may be the content providers that sit on the Internet that are separate from the ISPs and/or are value added services of the ISPs. A provider who is providing subscribers Internet accesses directly (e.g., without purchasing accesses from a wholesaler) may use or lease a redirect server from the wholesaler. In this case, according to one embodiment, the provider may use multiple contexts in order to provide different services to a variety of classes of subscribers. Alternatively, the provider may elect to use a single context for all of its subscribers as needed. The redirect server may also be used in a private network as well as in networks that provide Internet accesses. According to one embodiment, a provider may use the redirect server to redirect customer traffic to a captive portal, or to communicate important news to one or more subscribers. Alternatively, the provider may notify the subscribers regarding changes in the services the ISP is providing, etc. Other configurations may exist.

Subscriber sessions may be PPPoX (point-to-point protocol over X) sessions (where X represent a protocol such as Ethernet or ATM), Dynamic Host Configuration Protocol (DHCP), IEEE 1483 bridged, etc. Other protocols may be utilized. Subscribers' source addresses can be any addresses. Alternatively, subscribers' source addresses may be restricted as desired. Similarly, the original destination addresses can be any addresses, or they can be restricted as desired. Furthermore, the redirect destination addresses may be unrelated to the undirected destination address (e.g., on different physical subnet).

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent finite sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to apparatus for performing the operations herein. This apparatus may be specially constructed for the required purposes (e.g., software, hardware, and/or firmware, etc.), or it may comprise a general purpose computer selectively activated or reconfigured by a computer program stored in the computer. The instructions of such software, firmware, and computer programs may be stored in a machine readable medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, electrical optical, acoustical or other forms of prorogated signals (e.g., carrier waves, infrared signals, etc.) or any type of media suitable for storing electronic instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

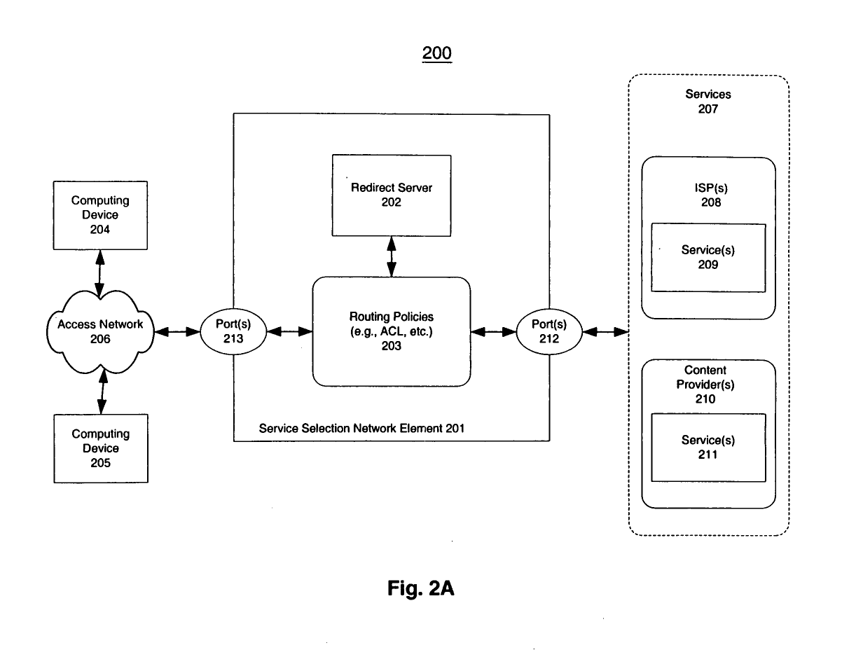

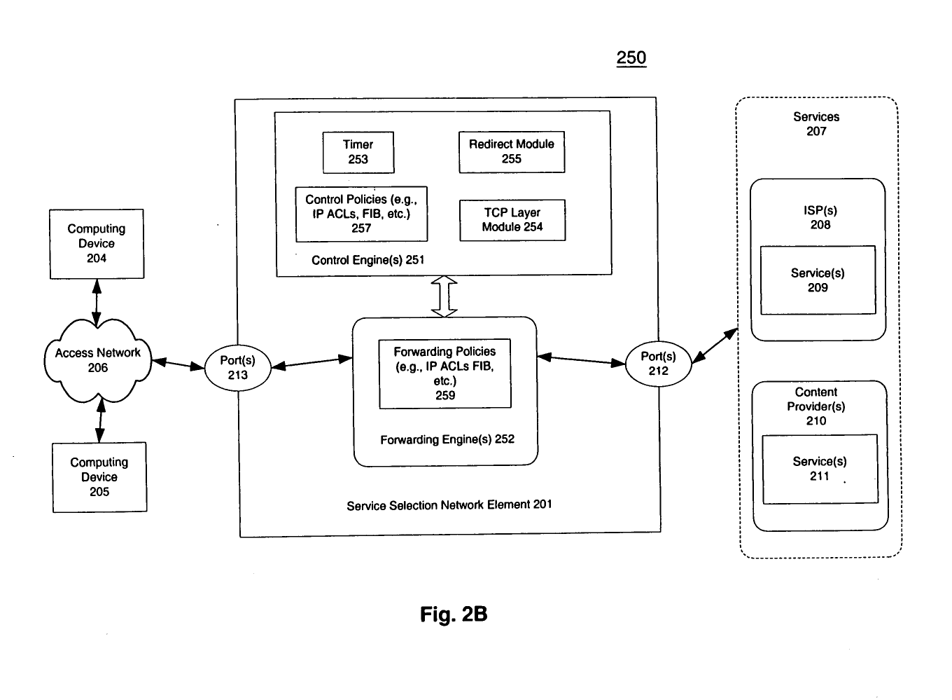

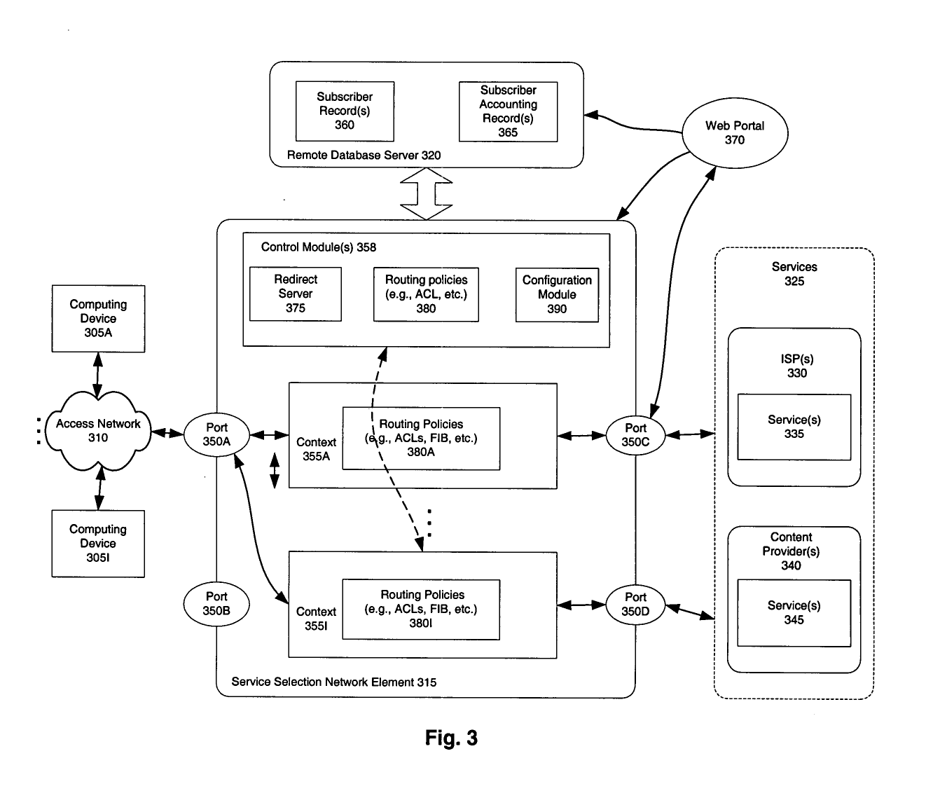

FIG. 2A is a block diagram illustrating an exemplary network configuration for redirection of packets according to one embodiment of the invention. Referring to FIG. 2A, exemplary system 200 includes, but not limited to, one or more computing devices 204 and 205 communicatively coupled to a number of services 207 through a service selection network element 201. Computing devices 204 and 205 may be coupled to one or more ports 213 of network element 201 via access network 206. Services 207 may include services 209 and 211 provided by one or more providers, such as ISPs 208 or content providers 210. In addition, network element 201 includes a built-in redirect facility, such as a redirect server 202, to handle redirect services for computing devices 204 and 205. In one embodiment, redirect server 202 is implemented as a HTTP redirect server. That is, the redirect server 202 only redirects the HTTP requests (e.g., based on a destination port of 80). Redirect server 202 may be implemented within a control card which may constitute at least a portion of a control engine 358 of FIG. 3. Alternatively, redirect server 202 may be implemented as a separate card communicatively coupled to the control card and the line cards via the communication medium. Portions of the control card and the line cards may operate and/or coordinate as one or more forwarding engines, such as forwarding engine 360 of FIG. 3, for handling forwarding packets to a destination, such as an external HTTP server or an internal redirect server (e.g., redirect server 202). According to one embodiment, the redirect services are based on one or more routing or redirect policies 203, which may be implemented on a per context basis (e.g., per virtual router basis), or alternatively, per subscriber basis.

According to one embodiment, a context represents module/units that each provides the functionality of a router, and thus operates as virtual routers in the service selection network element 201. Depending upon the configuration of the service selection network element 201, a context can be associated with a different provider or service (e.g., an Internet service provider, a content provider, etc.) to allow for separation of traffic of different providers (e.g., for accounting and other purposes). Where a given context is associated with a given provider, that context may include a number of subnets that comprise a number of addresses (e.g., Internet Protocol (IP) addresses) that are to be dynamically assigned to subscriber/clients. However, a different or additional allocation of contexts is within the scope of the invention (e.g., different services of a given provider may be allocated different contexts, certain providers may share a single context, etc.).

Referring back to FIG. 2A, network element 201 further includes multiple physical interfaces, such as ports 212 and 213. Ports 212 and 213 may be ATM ports, GigE ports, Frame Relay ports, etc.

In one embodiment, network element 201 may include one or more control cards and a number of line card communicatively coupled to the control card via communication medium. Each of the line cards may be coupled to a physical interface, such as ports 212 and 213, respectively. The control cards and the line cards may each include a machine readable medium, such as random access memory (RAM), to store the routing policies including redirect policies, such as context-based routing policies 203. Alternatively, routing policies 203 may be stored in a machine readable medium shared between the control card and the line cards.

According to one embodiment, when network element 201 receives a request from one of the computing devices 204 and 205 to access one of the services 207, such as services 209 provided by ISPs 208 or services 211 provided by content providers 210, network element 201 accesses one or more routing policies 203, such as access control lists (ACLs), which may be stored in a machine readable medium (e.g., memory, such as RAM) within the respective line card or a machine readable medium shared between the control card and the line cards to determine whether the request should be redirected to another destination. In one embodiment, the determination is performed based on the context information associated with the subscriber, or the connection session, etc. Alternatively, the routing policies 203 are designed to redirect all of the HTTP requests. That is, when network element 201 receives a packet from one of the computing devices 204 and 205, network element 201 examines the header of the packet, such as TCP/IP header of the packet, to determine whether the packet is an HTTP packet. Whether the packet is an HTTP packet may be determined based on conventional use of ports for the HTTP packets. In one embodiment, a packet is an HTTP packet when its destination port of the TCP header is directed to port 80. Alternatively, a packet is a secure HTTP (HTTPS) packet when its destination port is port 443. It will be appreciated that the routing policies may be configured (e.g., via an API, CLI (command line interface), a remote database server during authentication and/or authorization, etc.), to redirect traffic, based on a number of parameters, such as, for example, the source and destination IP addresses, the subscriber's MAC address, the source and/or destination ports, etc. Other context information may be used to specify redirect policies.

If it is determined that the packet should be redirected, based on the routing policies 203, the packet may be forwarded, via an internal logical interface, to redirect server 202 without invoking an external dedicated redirect server, contrary to a conventional approach. Once the redirect server 202 receives the redirected packet, redirect server 202 may also: examine the packet and based on a redirect policy corresponding to the context associated with the packet; determine the redirect address, such as redirect URL; and return the redirect address for incorporation into a reply packet(s) to cause the redirection. Redirect server 202 may also perform other operations similar to those performed by a regular redirect server. The redirect URL is forwarded back to the browser of the computing device. The browser of the computing device then may access the redirect destination, via network element 201 again, based on the redirect URL. Note that all of the redirect processes are performed within the network element 201 without invoking an external redirect server via a physical interface of the network element 201, which may require costly processes, such as, for example, rewriting the TCP/IP headers.

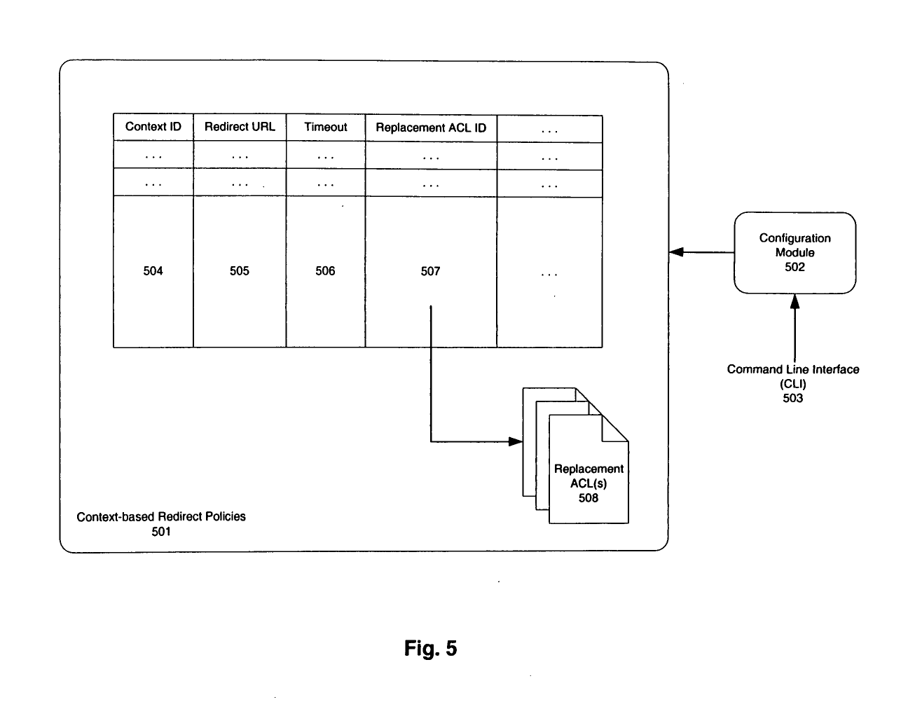

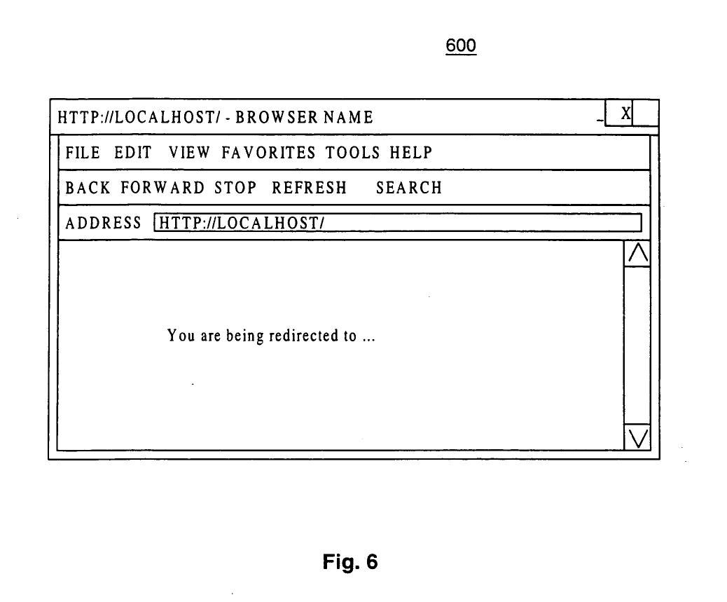

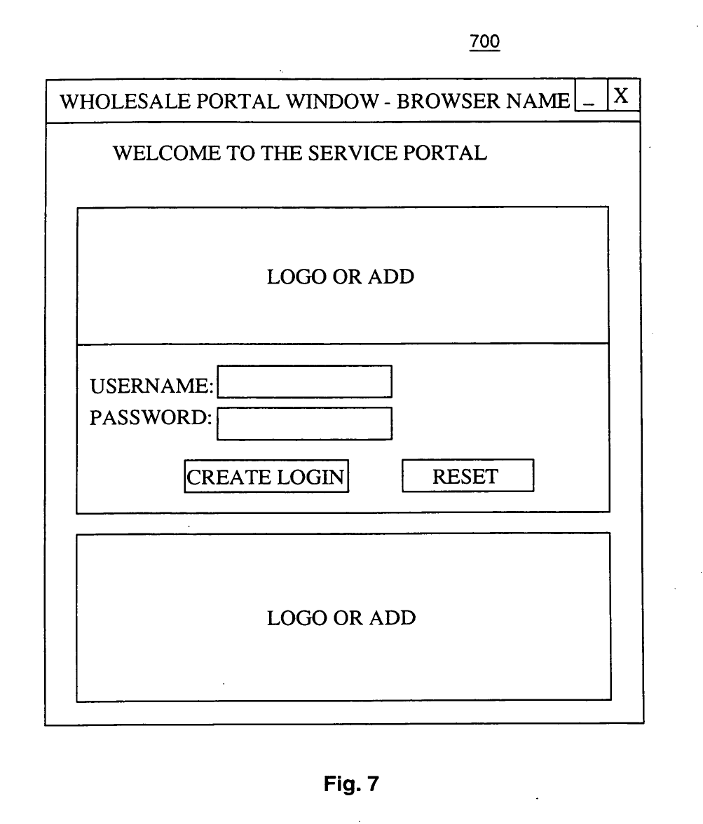

According to one embodiment, the routing or redirect policies may further include a timeout value, similar to routing policies 501 shown in FIG. 5. The timeout value may be used for the browser of the computing device to display a direct message, such as user interface 600 shown in FIG. 6, before accessing the redirect page addressed by the redirect URL, such as pages 700 of FIG. 7 respectively. In one embodiment, the timeout may be ranging from 0 to 5 seconds. Alternatively, the timeout may be any number, such as, for example, up to 600 seconds.

According to another embodiment, the routing policies may also be transitory (e.g., through amendment or replacement) without performing authentication, authorization, and accounting (AAA) again. For instance, the routing policies may include one or more replacement routing policies (e.g., a replacement ACL). The replacement policy may be used for the subsequent accesses after the initial redirect services. For example, initially, a client of computing device 204 tries to access services 207, such as services 211 (e.g., downloading music or video on demand) provided by one of content provider(s) 210. When the request is received at service selection network element 201 (e.g., a wholesaler), based on routing policies 203, such as an ACL (e.g., a first ACL), corresponding to the context associated with the respective connection, it is determined that the request should be redirect to another page because of one or more of a variety of reasons. One of the reasons could be that the client has not established his or her account and has not paid for the membership, etc. As a result, the request is redirected, via an internal logical interface to the redirect server 202. Redirect sever 202 retrieves a replacement URL, which has been set up via the respective routing policies or ACLs associated with the context of the connection, and causes the return of the replacement URL to the client.

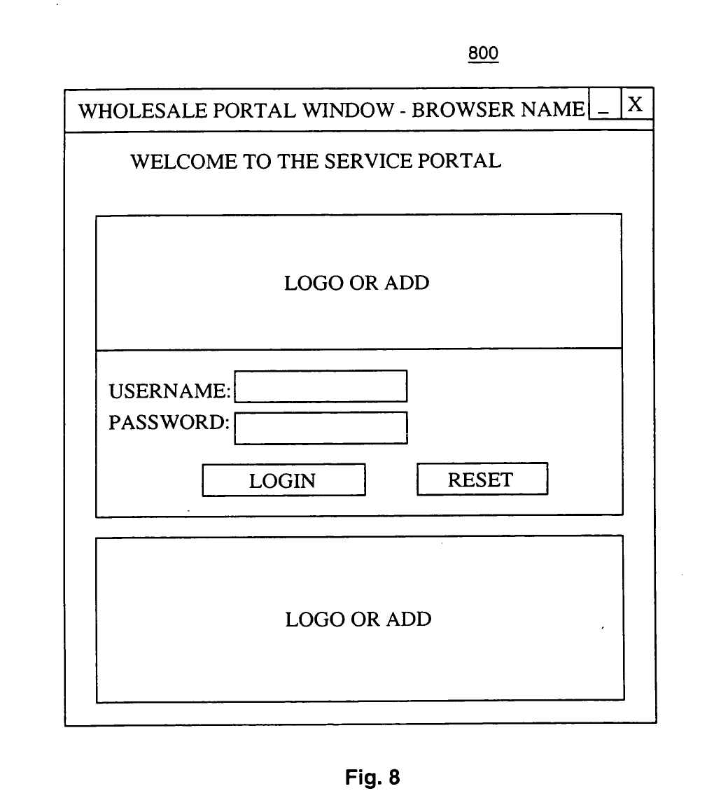

The return packet returned to the client may include a timeout value. The timeout value may be used by the client's browser to display a redirect message, similar to user interface 600 of FIG. 6 for a period of time specified by the timeout value. Once the timeout expires, the client's browser may access a page addressed by the replacement URL, such as, for example, user interface 700 shown in FIG. 7 according to one embodiment. On page 700, the user may establishes his/her account and pay the membership fee, etc. Thereafter, the user may continue to access the Web pages provided by content providers 210. Once the initial ACL has been executed, network element 201 may replace the original ACL with the replacement ACL which may be provided by the original ACL (e.g., via a link). As a result, when a subsequent request is received at network element 201, network element 201 may examine the replacement ACL, instead of the original ACL, and may allow the user to continue to access where the user desires to go without redirection, such as, for example, page 800 as shown in FIG. 8 to login and to download the requested content from the respective content provider (e.g., services 211 provided by content providers 210).

It will be appreciated that the redirect services are not limited to those as discussed above. According to one embodiment, the redirect services may also be used for advertisement practice. For example, a user may initially launches a browser to access a Web page. The routing policies maintained by the network element 201 may redirect the user, at the first time, to another Web page which may display an advertisement image for a period of time. After the time period expires, which may be configured via the routing policies, the user may be allowed to continue to access other Web pages. Subsequent accesses by the user may directly access the intended Web pages without redirections. The redirection may be activated every time the browser is launched. Alternatively, the redirection may be activated once a day, preferably the first time in the day, or other schedules which may be configured within the one or more routing policies, such as routing policies 203.

FIG. 2B is a block diagram illustrating an alternative view of an exemplary network configuration for redirecting packets according to an embodiment of the invention. In this embodiment, exemplary network element 201 includes, but not limited to, a control engine 251 and forwarding engine 252. In one embodiment, control engine 251 includes a TCP layer processing module 254, a redirect module 255, one or more control policies 257, and a timer 253. TCP layer processing module 254 is responsible for handling TCP layer associated processes, including, but not limited to, determining whether a given packet needs to be redirected to an alternative destination, based on, for example, one or more control policies 257. Control policies 257 may include one or more routing policies associated with the context or subscriber of the packet, similar to routing policies 500 of FIG. 5.

According to one embodiment, the one or more routing policies may include a timeout value which used by the timer 253 to control a period of time that a redirect message will be displayed at a browser of the corresponding computing device before redirecting to an alternative destination (e.g., a redirect destination).

Forwarding engine 252 may also include one or more forwarding policies 259 to control how a packet is being forwarded. The forwarding policies 259 may be the same or a subset of the control policies 257. Policies 257 and 259 may be stored in a machine readable medium within the respective control engine 251 and forwarding engine 252. Alternatively, policies 257 and 259 may be stored in a machine readable medium shared by the control engine 251 and forwarding engine 252.

According to one embodiment, when forwarding engine 252 receives a packet destined to a destination, such as providers 208 and 210, the forwarding engine 252 determines whether the packet needs to be redirected to an alternative destination. The determination may be performed based on the information stored in the one or more policies 259. The policies 259 may include IP ACLs, a FIB (forwarding information base), etc. The forwarding policies associated with the packet (e.g., based on the context or subscriber associated with the packet) may indicate that the packet needs to be redirected. Alternatively, the policies 259 may not include forwarding information regarding the packet, in this case, the forwarding engine 252 could not determine how to forward this packet. As a result, the forwarding engine 252 just forwards the packet to the control engine 251 to let the control engine 251 to decide how to handle this packet.

When the control engine 251 receives the packet forwarded from the forwarding engine 252, the TCP layer module 254 may examine the packet, particularly, the TCP header of the packet, to determine whether the packet needs to be redirected based on the one or more policies 257 associated with the subscriber. In one embodiment, the TCP module 254 examines whether the destination port of the TCP header is destined to port 80, which indicates whether the packet is a HTTP packet. Alternatively, TCP module 254 examines whether the destination port of the TCP header is destined to port 443, which indicates whether the packet is a secure HTTP packet. Other ports that may be used by HTTP packets may be utilized to determine whether a specific packet is an HTTP packet. If the TCP module 254 determines that the packet needs to be redirected, the TCP module 254 forwards the packet to redirect processing module 255. The redirect processing module 255 may look up the routing policies corresponding to the packet, for example, based on the context or subscriber of the packet, to determine a redirect destination (e.g., a replacement URL). The redirect processes module 255 imbeds the replacement URL in a return packet. Thereafter, the control engine 251 returns the return packet having the redirect URL back to the forwarding engine 252. In addition, according to one embodiment, control engine 251 may swap the source and destination IP addresses in the return packet to impersonate the intended recipient of the original packet. As a result, when the forwarding engine 252 receives the returned packet, the forwarding engine 252 can forward the return packet back to the originator of the packet. The return packet may further include a timeout value specified by the associated redirect policies to allow the browser of the respective computing device to display a redirect message for a specified period of time. Therefore, the browser of the corresponding computing device may access the alternative destination based on the redirect policies (e.g., the replacement URL). The redirect services may be on a permanent basis or a temporary basis, which is controlled by the timer 253.

FIG. 3 is a block diagram illustrating an exemplary network configuration for redirection of packets according to another embodiment of the invention. Referring to FIG. 3, a number of computing devices 305A-I can be communicatively coupled to a number of services 325 through a service selection network element 315. In FIG. 3, the services 325 include services provided by one or more Internet service providers 330 and one or more content providers 340. Each of the Internet service providers 330 and content providers 340 may offer one or more different services (335, 345) (e.g., speeds of connection, particular content, etc.). Thus, the term service is used herein to include grades of network connections, accessibility of different items of content, etc. Each of the services can be represented by a number of different attributes, including type of media, amount of bandwidth, filters, type of usage (e.g., time based, prepaid, etc.), etc. FIG. 3 also illustrates an optional web portal 370 to allow the computing devices 305A-I to login and/or select/change between the services 325.

FIG. 3 illustrates the service selection network element 315 having a number of ports 305A-D, a number of contexts 355A-I, and a set of one or more control modules 358. Each of the contexts 355A-I represents module/units that each provides the functionality of a router, and thus operates as virtual routers in the service selection network element 315. Depending upon the configuration of the service selection network element 315, each of the contexts 355A-I can be associated with a different provider or service (e.g., an Internet service provider, a content provider, etc.) to allow for separation of traffic of different providers (e.g., for accounting and other purposes). Where a given context 355 is associated with a given provider, that context may include a number of subnets that comprise a number of addresses (e.g., Internet Protocol (IP) addresses) that are to be dynamically assigned to subscriber/clients. However, a different or additional allocation of contexts is within the scope of the invention (e.g., different services of a given provider may be allocated different contexts, certain providers may share a single context, etc.).

By way of example, the computing devices 305A-I are coupled to the port 350A by an access network 310. In contrast, the ports 350C-D are used for communicating with the services 325 and the optional web portal 370. It should be understood that the orientation and representation of ports of the service selection network element 315 are simply for illustration purposes, and thus they are not restrictive upon the scope of the invention. In addition, it should be understood that any number of ways can be used for providing communication between the ports 350C and 350D of the service selection network element 315 and the web portal 370 and the services 325 according to well known techniques (e.g., a connection over the Internet, such as a virtual private network (VPN) using, for example, GRE tunneling, L2TP tunneling, ATM/FR logical channels, 802, 1Q VLANS, direct IP connectivity, MPLS L2/L3 VPNS etc). Furthermore, it should be understood that the optional Web portal 370 and remote database server 320 are optional components and they are not required in order to operate certain embodiments of the invention.

Different communication sessions between the computing devices 305 and the web portal 370/services 325 travel through one of the contexts 355A-I. Thus, each of the contexts 355A-I have interfaces to provide communication to the appropriate ones of the services 325, and also have interfaces to which the computing devices may be bound depending upon the service that has been selected by a subscriber. Thus, although FIG. 3 illustrates messaging and operations related to one port coupled to one interface of a context, the different ports, interfaces and contexts of the network element 315 can include the messaging and operations illustrated. While in one embodiment of the invention a number of interfaces are associated with a given port, in alternative embodiments of the invention a single interface is associated with a given port.

Web portal 370 allows subscribers to log in and/or select/switch between the services and providers. Responsive to such action by a given subscriber, web portal 370 causes a record (e.g., subscriber records 360 and subscriber accounting records 365) of that subscriber to be altered to reflect the action and causes the service selection network element to attempt to connect the subscriber accordingly.

According to one embodiment, web portal 370 may include a web page, similar to page 700 of FIG. 7 to allow a new subscriber to login. In this manner, a new subscriber connecting to the service selection network element 315 is provided with an opportunity to establish a portal user name and portal password for service selection, as well as select a service to be connected with as offered by the provider(s). With the page 700 of FIG. 7, a new subscriber can self-provision one of the available services provided by one of the available provider(s).

According to another embodiment, web portal 370 may also provide a web page, similar to page 800 of FIG. 8, to allow a known subscriber login. In certain embodiments of the invention, the known subscriber login page of FIG. 8 is provided to the subscriber either: 1) as the result of a redirect policy that requires a subscriber to login each time that subscriber reconnects; or 2) as a result of a subscriber pointing their web browser to the web portal. FIG. 8 is a diagram illustrating a known subscriber package change (e.g., providers and service types drop-down menu) pop-up window according to one embodiment of the invention. With the page 800 of FIG. 8, an existing subscriber can self-provision a different one of the available services provided by one of the available providers. Additional information may be collected through the web portal (e.g., with other pop-up windows) from an unknown subscriber or when a known subscriber changes (e.g., payment method, contact information, etc.)

Thus, web portal 370 provides a service selection gateway. While one embodiment of the invention is described in which the login and package select/change pop-up windows are implemented as two separate windows, alternative embodiments of the invention may use the same, more or different pop-up windows. In addition, while embodiments of the invention are described in which the providers and services of those providers are selected from using a drop-down menu, alternative embodiments of the invention may use any type of selection mechanism. While in one embodiment of the invention the service portal pop-up windows resemble dial-up windows, alternative embodiments of the invention use a different type of window. In addition, while in certain embodiments of the invention these windows pop away upon successful entry of information and/or canceling, alternative embodiments require the subscriber to close the window. In addition, according to one embodiment, Web portal 370 may be maintained within the service selection network element 315. Alternatively, Web portal 370 may be maintained by a service provider, such as ISPs 330 or content providers 340. Furthermore, Web portal 370 may be maintained by a third party. Other configurations may exist.

The control modules 358 handle various communications, protocols, network connections, bindings, etc. Additional details regarding various architectures for the service selection network element 315 are described later herein. While one embodiment is illustrated in which contexts are used inside the service selection network element 315, alternative embodiments of the invention do not use contexts.

FIG. 3 also illustrates a remote database server 320 storing data related to authentication, authorization and accounting (AAA) for subscribers. In particular, FIG. 3 shows the remote database server 320 including subscriber records 360 and subscriber accounting records 365. In one embodiment, a given computing device 305A-I coupled to the network element 315 has an associated subscriber record 360 and an associated subscriber accounting record 365. While FIG. 3 illustrates the subscriber records as part of the remote database server 302, it should be understood that they may reside on equipment of different providers. While in one embodiment of the invention each subscriber record 360 includes certain information (e.g., the username and password shared between the subscriber and the provider; a set of policies, such as redirect policies), in alternative embodiments of the invention more, less or different information may be stored therein. In alternative embodiments of the invention more, less or different information may be stored therein.

While in one embodiment of the invention the remote database server 320 is a Remote Access Dial In User Server (RADIUS) server (e.g., with a sequel (SQL) database, such as MySQL), alternative embodiments of the invention may use additional RADIUS servers and/or instead or additionally use other types of servers. It should be understood that any number of ways can be used for providing communication between the remote database server 320 and the service selection network element 315 according to well known techniques (e.g., a connection over the Internet, such as a VPN carrying a software program/script (e.g., perl based scripting, for RADIUS attribute/element modification and Pre-emptive Hypertext Processor (PHP) based web interfacing to link the necessary databases of both). In addition, while FIG. 3 illustrates that the service selection network element 315 and the remote database server as two separate elements, embodiments of the invention are not so limited. For example, in alternative embodiments, the database server 320 and/or the records therein can be incorporated into the service selection network element 315.

The access network 310 may be one or more local area network (LAN), wide area network (WAN), or a combination thereof. The access network 310 represents any number of different access networks using any number of different types of encapsulations, including PPPoX, 1483 bridged, and DHCP etc.

In addition, according to one embodiment, control module 358 includes a redirect server 375 for handling redirect services received from contexts 355A-I, via internal logical interfaces. Control module 358 further includes a set of routing policies 380 and a configuration module 390 which may be used to configure the routing policies 380 and other settings of the network element 315. Each of contexts 355A-I may also include a set of routing policies, such as ACLs, which may or may not be the same routing policies 380 of control module 358. Routing policies 380 and 380A-I may be stored in a machine readable medium, such as the RAM.

In certain embodiments of the invention, the routing policies 380 and 380A-I may include an internal redirect policy. A redirect policy indicates that the subscriber should be redirected to an alternative destination, such as web portal 370. Different embodiments of the invention may allow for the configuration of the redirect policy for different situations. For example, a redirection policy may be included for at least certain known subscribers to require them to login. Such a forced redirection to the web portal 370 ensures that such subscribers will receive a home page (e.g., of the web portal 370), such as, for example, page 800 of FIG. 8, that can include information and/or advertising (thus, a wholesaler operating the service selection network element can enforce a login page where a subscriber must select his desired destination, instead of such selection occurring through the subscriber entering at their computing device a network address as a domained PPP username). As another example, a redirection is used for new subscribers in order to establish a record of them and allow them to self-select their service, such as, for example, page 700 of FIG. 7. While in certain embodiments of the invention, a separate context is used for unknown subscribers (referred to as the portal context), alternative embodiments of the invention do not use a separate context and/or do not implement contexts at all. The Web portal 370 may be maintained by the owner of the service selection network element 315 (e.g., the wholesaler). Alternatively, Web portal 370 may be maintained by the owner of services 325, such as ISPs 330 or content providers 340.

Referring to FIG. 3, according to one embodiment, when network element 315 receives, via a line card, a request from one of the computing devices 355A-I to access one of the services 325, such as one of services 335 provided by one of ISPs 330 or one of services 345 provided by one of content providers 340, network element 315 accesses one or more routing policies 380A-I, such as access control lists (ACLs), which may be stored in a machine readable medium, such as RAM, within the respective line card or a memory shared between the control card and the line cards to determine whether the request should be redirected to another destination, such as Web portal 370. In one embodiment, the determination is performed based on the context information associated with the subscriber, the connection session, etc. Alternatively, the routing policies may be designed to redirect all of the HTTP requests. That is, when network element 315 receives a packet from one of the computing devices 355A-I, network element 315 examines the header of the packet, such as TCP/IP header of the packet, to determine whether the packet is an HTTP packet. In one embodiment, a packet is an HTTP packet when its destination port of the TCP header is directed to port 80 or port 443, as well as other ports used by an HTTP packet. Alternatively, other context information, such as source and/or destination IP addresses, source and/or destination ports, may be used by the routing policies, etc. Furthermore, there may be multiple routing policies that may be selected as a result of AAA (authentication/authorization/accounting) processes.

If it is determined that the packet should be internally redirected, based on the routing policies, the packet may be forwarded, via an internal logical interface, to redirect server 375. Once the redirect server 375 receives the redirected packet, redirect server 375 may also: examine the packet and based on a redirect policy corresponding to the context associated with the packet; determine the redirect address, such as redirect URL 505 of policies 501 shown in FIG. 5; and return the redirect address. Redirect server 375 also performs other operations similar to those performed by a regular redirect server, such as swapping the source and destination IP addresses in the header to impersonate the intended recipient or destination. Once the forwarding engine receives the redirect URL from redirect server 375 in a reply packet, the redirect URL may be forwarded back to the browser of the computing device. The browser of the computing device then may access the redirect destination, via network element 315 again, based on the redirect URL, which may be pointed to Web portal 370. Note that all of the redirect processes are performed within the network element 315 without invoking an external redirect server via a physical interface of the network element 315, which may require costly processes, such as, for example, rewriting the TCP/IP headers.

According to one embodiment, the routing or redirect policies may further include a timeout value, such as timeout 406 of routing policies 501 shown in FIG. 5. The timeout value may be used for the browser of the computing device to display a direct message, such as user interface 600 shown in FIG. 6, before accessing the redirect page addressed by the redirect URL, such as pages 700 of FIG. 7 respectively. The timeout may be any number, preferably up to 600 seconds according to one embodiment.

According to another embodiment, the routing policies may also include a transitory routing policies, such as replacement ACLs 508, which are linked with the replacement ACL ID 507 of the initial policies. The replacement policy may be used for the subsequent accesses after the initial redirect services.

The service selection network element 315 can be implemented a variety of ways. In a particular embodiment, the service selection network element includes, but not limited to, one or more control cards providing a control engine (e.g., hosting control module 358 and optionally certain aspects of the different contexts) and a set of one or more forwarding cards providing, a forwarding engine (e.g., hosting the rest of the aspects of the contexts). Each of the forwarding cards may include a processor and memory. The control card(s) and the forwarding cards may be coupled to system bus(es). The control card performs control, system configuration and management tasks for the network element. For example, if the forwarding card needs to be updated with a new Internet Protocol (IP) address table, such data is received by the control card and transmitted to the forwarding card, wherein such data is updated therein.

This implementation of the service selection network element is an example, and not by way of limitation. Thus, network elements having other architectural configurations can incorporate embodiments of the invention. Examples of other network elements that could incorporate embodiments of the invention could have multiple forwarding cards or have a single line card incorporating the functionality of both the forwarding and the controlling. Moreover, a network element having the forwarding functionality distributed across the traffic cards could incorporate embodiments of the invention.

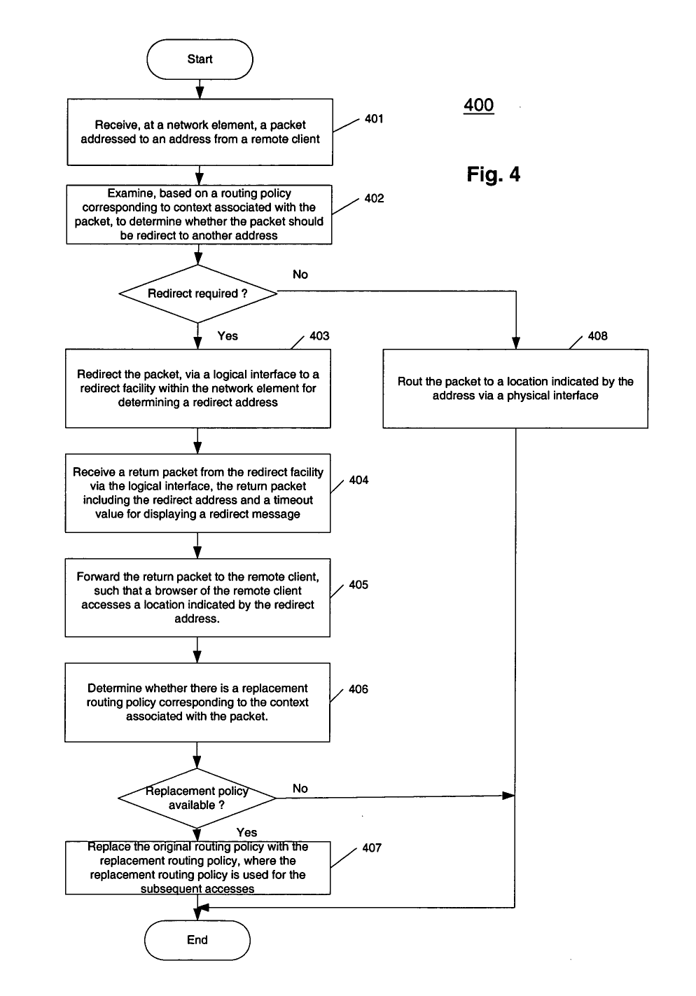

FIG. 4 is a flow diagram illustrating an exemplary process for redirection of requests according to one embodiment of the invention. Exemplary process 400 may be performed by processing logic that may comprise hardware (circuitry, dedicated logic, etc.), software (such as is run on a general purpose computer system or a dedicated machine), or a combination of both. In one embodiment, exemplary process 400 includes receiving at the network element a packet from a remote client, the packet being addressed to a destination, examining, based on one or more policies corresponding to context associated with the packet, to determine whether the packet should be redirected to another destination, forwarding the packet, via a logical interface, to a redirect facility within the network element if the packet should be redirected to another destination, and forwarding a return packet from the redirect facility to the remote client, the return packet including a redirect address associated with another destination.

Referring to FIGS. 3 and 4, at block 401, network element 315 receives a packet from a computing device (e.g., computing devices 355A-I) addressed to a destination, which may be services 335 or 345 provided by ISPs 330 or content providers 340. The packet may be processed by a process with respect to the context associated with the respective connection (e.g., particular session or subscriber). At block 402, the respective process corresponding to the associated context examines, based on one or more routing policies, such as policies 380A-I, corresponding to the context associated with the packet, to determine whether the packet should be redirect to another destination, such as Web portal 370. If it is determined that the packet should be redirected, at block 403, the packet is forwarded, via an internal logical interface, to a redirect facility or server, such as redirect server 375, within the network element 315 for redirect processes. At block 404, the redirect server retrieves a replacement URL from the routing policies and embeds the replacement URL within a return packet which is received by the respective context. In addition, the redirect server may further impersonate the intended recipient or destination by swapping the source and destination IP addresses within the IP header of the return packet, such that the browser of the originated computing device recognizes the return packet as the expected return packet returned by the intended recipient or destination. The redirect server also performs other redirect operations similar to those performed by a regular redirect server. In one embodiment, the return packet includes a timeout value and optionally a replacement routing policies or ACLs. At block 405, the return packet is forwarded by the respective context to the computing device that originated the request. Thereafter, a browser of the computing device displays a redirect message, similar to those shown in user interface 600 of FIG. 6, for a period of time determined by the timeout value. Once the timer expires, the browser accesses a destination specified by the replacement URL, such as, for example, Web portal 370 via port 350C, which may contain a page similar to page 700 of FIG. 7.

At block 406, the respective process associated with the context determines, based on the routing policies similar to policies 501 of FIG. 5, whether there is a replacement routing policy corresponding to the context (e.g., context ID 504) associated with the packet. If there is a replacement routing policy (e.g., replacement ACL) for the respective context associated with the packet, at block 407, the replacement policy may be used for any subsequent accesses associated with the context by that subscriber. However, at block 402, if it is determined that the packet does not need to redirect, at block 408, the packet is routed according to the destination (e.g., destination IP address) within the packet via a physical interface, such as port 350C. Other operations may be included.

FIG. 5 is a block diagram illustrating exemplary redirect policies according to one embodiment of the invention. Exemplary redirect policies 501 may be implement as a part of routing policies 380 and 380A-I of FIG. 3. Exemplary redirect policies 501 may be stored in a memory of the respective control card or the line cards. Alternatively, exemplary redirect policies 501 may be stored in a memory shared by the control card and the lines cards. While in one embodiment of the invention, each policy is implemented on a per context basis (indicated by context ID 504), alternative embodiments may use other techniques (e.g., one policy for the whole network element; a number of policies for the network element selected from for each subscriber based on the results of AAA; a number of policies per context selected from for each subscriber based on a context and policy indicated in the results of AAA, etc.) Each policy may also include optionally be a transitory policy (e.g., a replacement URL 505 for the redirect purposes). Optionally, each policy may include a timeout value 506 to specify a time period for displaying a redirect message at a browser of the respective computing device and a replacement ACL ID which may be reference or a pointer linking with one or more replacement policies 508.

In addition, exemplary redirect policies 501 may be configured, via configuration module, by a user or an administrator through a user interface, such as a command line interface (CLI) 503. According to one embodiment, HTTP redirection may be configured using the following exemplary command via the CLI 503:
http-redirect url url[timeout[interval]]
   Where parameter “url url” is used to specify a URL to which the subscriber is to be redirected when HTTP traffic is detected. The length of the URL may be limited to 256 characters or less. Parameter “timeout” is an optional parameter to allow a redirect message be displayed before accessing the specified URL. If parameter “interval” is not provided, or if the parameter “timeout” is not provided, the redirect message will be displayed for one second, according to one embodiment. Parameter “interval” is an optional parameter which is used with parameter “timeout”. Parameter “interval” is used to request a number of seconds for which the browser is to display a redirect message before accessing the specified URL. The parameter “interval” may be ranging from zero to 600 seconds according to some embodiments. Note that the browser has control over whether the request is honored. A redirect message may be simply a notice to the effect that the subscriber is being redirected to a URL other than the one the subscriber requested. Typically, browsers may interpret an “interval” parameter value of zero to mean that a redirect message is not to be displayed at all. Similarly, the HTTP redirect services may be disabled using the following exemplary instruction:
no http-redirect

According to one embodiment, redirection of HTTP traffic also requires that an HTTP redirect policies or ACLs be configured prior to the redirect services activated. According to one embodiment, a redirect ACL may be configured using the following exemplary instruction:
redirect if-name next-hop {src[src-wildcard] |any|host src} [watch criteria] [log]
   Where parameter “if-name” is the name of the interface through which packets matching the criteria are to be redirected. Parameter “next-hop” is an IP address to which packets matching the criteria are to be redirected. Parameter “src” is the source IP address to be included in the redirect criteria. Parameter “src-wildcard” is an optional parameter to provide an indication of which bits in the “src” parameter are significant for purposes of matching. Parameter “any” is used to specify a completely wild-carded source IP address indicating that IP traffic to or from all IP addresses is to be included in the redirect criteria. Parameter “host src” is the address of single-host source with no wild-carded address bits. Parameter “watch criteria” is the criteria for which the ACL is to watch for traffic coming from the subscriber. If this parameter is present, the redirect entry in the ACL does not become active until traffic from the subscriber matches that specified in the “watch criteria” parameter. The criteria may include, but not limited to, the source or destination IP addresses and the source and destination ports, etc. Note that the command line instructions are not limited to those discussed above. Other instructions or formats apparent to those with ordinary skill in the art may be utilized.

Thus, methods and apparatuses for redirect messages have been described. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A method in a single network element, the method comprising:
receiving, at the network element, a packet from a remote client, the packet being addressed to a destination;
examining, based on one or more policies associated with the packet, to determine whether the packet should be redirected to another destination;
forwarding the packet, via a logical interface, to a redirect facility within the network element if the packet should be redirected to another destination; and
forwarding a return packet from the redirect facility to the remote client, the return packet including a redirect address associated with another destination.

2. The method of claim 1, further comprising routing the packet, via a physical interface, to a destination indicated by a destination address within the packet or based on the one or more routing policies, if the packet is determined not to be redirected to another destination.

3. The method of claim 1, further comprising specifying a timeout value within the return packet to indicate a time period within which a redirect message is displayed at the remote client.

4. The method of claim 3, wherein the timeout value is determined based on the one or more routing policies associated with the packet.

5. The method of claim 1, further comprising configuring the one or more policies via an application programming interface (API).

6. The method of claim 1, further comprising:
determining whether one or more replacement routing policies exist for the context associated with the packet; and
replacing the original routing policies with the replacement routing policies for subsequent accesses, if the replacement routing policies exist.

7. The method of claim 1, wherein whether the packet should be redirected to another destination is determined based on whether the packet is an HTTP (hypertext transport protocol) packet.

8. A machine-readable medium having executable code to cause a machine to perform a method in a single network element, the method comprising:
receiving, at the network element, a packet from a remote client, the packet being addressed to a destination;
examining, based on one or more policies associated with the packet, to determine whether the packet should be redirected to another destination;
forwarding the packet, via a logical interface, to a redirect facility within the network element if the packet should be redirected to another destination; and
forwarding a return packet from the redirect facility to the remote client, the return packet including a redirect address associated with another destination.

9. The machine-readable medium of claim 8, wherein the method further comprises routing the packet, via a physical interface, to a destination indicated by a destination address within the packet or based on the one or more routing policies, if the packet is determined not to be redirected to another destination.

10. The machine-readable medium of claim 8, wherein the method further comprises specifying a timeout value within the return packet to indicate a time period within which a redirect message is displayed at the remote client.

11. The machine-readable medium of claim 10, wherein the timeout value is determined based on the one or more routing policies associated with the packet.

12. The machine-readable medium of claim 8, wherein the method further comprises configuring the one or more policies via an application programming interface (API).

13. The machine-readable medium of claim 8, wherein the method further comprises:
determining whether one or more replacement routing policies exist for the context associated with the packet; and
replacing the original routing policies with the replacement routing policies for subsequent accesses, if the replacement routing policies exist.

14. The machine-readable medium of claim 8, wherein whether the packet should be redirected to another destination is determined based on whether the packet is an HTTP (hypertext transport protocol) packet.

15. A single network element, comprising:
a control engine having a redirect unit to redirect packets based on one or more routing policies associated with the packets; and
a forwarding engine coupled to the control engine to receive a packet from a remote client and to forward the packet to the redirect unit of the control engine for redirect processes.

16. The single network element of claim 15, further comprising a storage unit to store the one or more routing policies.

17. The single network element of claim 16, wherein the storage unit further stores one or more replacement policies, which when activated, are used to replace the original one or more routing policies for subsequent accesses.

18. The single network element of claim 15, further comprising a configuration unit to allow a user to configure, via an application programming interface (API), the one or more routing policies.

19. The single network element of claim 15, wherein the forwarding engine forwards the packet to the control engine if the packet is destined to a predetermined port.

20. The single network element of claim 15, wherein the forwarding engine forwards the packet to the control engine if the packet is an HTTP packet.
